(19) United States
(12) Patent Application Publication
(10) Pub. No.: US 2018/0361353 A1
(43) Pub. Date: Dec. 20, 2018

(54) Separating Agent for Chromatography, Chromatography Column, and Method for Separation by Chromatography

(71) Applicant: Shinwa Chemical Industries Ltd., Kyoto-shi (JP)

(72) Inventor: Kosuke FUKUZAWA, Kyoto-shi (JP)

(21) Appl. No.: 16/060,141

(22) PCT Filed: Dec. 20, 2016
(86) PCT No.: PCT/JP2016/087971

§ 371 Date: Jun. 7, 2018

(30) Foreign Application Priority Data
Dec. 25, 2015 (JP) 2015-254636
Apr. 8, 2016 (JP) 2016-078091

(51) Int. Cl. B01J 20/283; B01J 20/30; B01J 20/291

(52) U.S. Cl. CPC B01J 20/283; B01J 20/3085; B01J 2220/4806; B01J 2220/52; B01J 20/291

(57) ABSTRACT

The present invention provides a chromatographic separating agent which exhibits excellent performances in separation of organic compounds, such as reducing sugars without formation of Schiff bases and anomer separation in analysis of saccharides. The chromatographic separating agent includes a porous substrate surface-modified with silane functional groups represented by the formula:

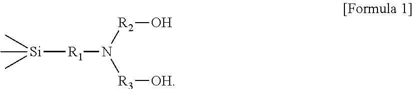

wherein R₁ represents an alkylene group or oxyalkylene group having a carbon number of 1 to 10. R₂ and R₃ independently represent an alkylene group or alkyleneoxyalkylene group having a carbon number of 1 to 6.

### TECHNICAL FIELD

The present invention relates to a chromatographic separating agent, a chromatographic column, and a chromatographic separating method.

### BACKGROUND ART

Chromatographic separating agents are materials packed or formed in a chromatographic column to serve as stationary phases. Silica gel is a commonly used chromatographic separating agent, and has advantages of high physical strength and large specific surface area.

Recently have been disclosed separating agents of silica gel with amino groups or amine-containing groups bonded on their surfaces (i.e. surface-modified silica gel) for improving chromatographic performances. For example, Patent Document 1 (JPH01-96009) discloses a separating agent produced by converting primary amines of aminopropylated silica gel to tertiary amines by crosslinking. Patent Document 2 (JP2006-321844) discloses a separating agent as primary amine produced by reacting bis(aminoalkyl)tetraalkyldisiloxane with silica gel. Patent Document 3 (US2010/0300972A1) and Patent Document 4 (US2006/0021939A1) disclose separating agents which have a secondary amine and a cyclic structure and are produced by reacting a copolymer of divinylbenzene and N-vinylpyrrolidone with amines having a piperazine structure. Patent Document 5 (US2005/0023203A1) discloses a highly hydrophobic separating agent produced by bonding tertiary amines to silica gel.

### CITATION LIST

### Patent Documents

Patent Document 1: JPH01-96009

Patent Document 2: JP2006-321844

Patent Document 3: US2010/0300972A1

Patent Document 4: US2006/0021939A1

Patent Document 5: US2005/0023203A1

### SUMMARY OF INVENTION

Analysis of saccharides using a traditional separating agent as a stationary phase has some issues. For example, analysis of saccharides in a HILIC (hydrophilic interaction chromatography) mode may use one or more amino columns with aminopropyl-bonded silica gel in some cases. Unfortunately, in analysis of reducing sugars using such amino columns, primary amines in the stationary phase may react with reducing sugars of interest to form imines, known as Schiff bases, resulting in non-elution of the reducing sugars from the columns. It is a serious issue especially in analysis of trace amounts of reducing sugars. Another issue is that a stationary phase containing secondary amines adversely affects analysis of reducing sugars because the secondary amines may react with the reducing sugars to form enamines.

Yet another issue is that analysis of reducing sugars present in the form of two diastereomers may cause anomer separation resulting in formation of undesirable split peaks if the conversion rate is low between the diastereomers. The anomer separation can be prevented by (i) accelerating the anomer conversion through a basic stationary phase so that one of the isomers is predominantly present, or (ii) controlling the analytical temperature at 80° C. to accelerate the anomer conversion. Unfortunately, in analysis with a silica gel-based stationary phase, a high-temperature aqueous solution at 80° C. passing through a column may cause elution of the silica gel under basic conditions, and also may cause a slight elution of the silica gel under neutral conditions. In particular, silica gel readily degrades under high pressure.

The inventor has arrived at a chromatographic separating agent which exhibits excellent performances in separation of organic compounds, such as reducing sugars without formation of Schiff bases and anomer separation in analysis of saccharides, by surface modification of a porous substrate with specific silane functional groups having a tertiary amine and terminal hydroxyl groups.

Accordingly, an object of the invention is to provide a chromatographic separating agent which exhibits excellent performances in separation of organic compounds, such as reducing sugars without formation of Schiff bases and anomer separation particularly in analysis of saccharides.

One embodiment of the present invention provides a chromatographic separating agent comprising a porous substrate surface-modified with silane functional groups represented by the formula:

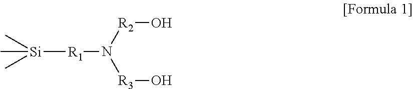

wherein R₁ represents an alkylene group or oxyalkylene group having a carbon number of 1 to 10; R₂ and R₃ independently represent an alkylene group or alkyleneoxyalkylene group having a carbon number of 1 to 6.

Another embodiment of the invention provides a chromatographic column comprising:

a cylindrical column body; and

the chromatographic separating agent packed or formed in the column body.

Yet another embodiment of the invention provides a chromatographic separating method comprising the step of separating a plurality of substances using the chromatographic separating agent.

### BRIEF DESCRIPTION OF DRAWINGS

FIG. 1 illustrates calibration curves of D-(+)-xylose, D-(+)-glucose, and D-(−)-mannitol, respectively, prepared in Example 1.

FIG. 2 illustrates a chromatogram of the saccharide mixture sample of Example 1.

FIG. 3 illustrates calibration curves of D-(+)-xylose, D-(+)-glucose, and D-(−)-mannitol, respectively, determined in Comparative Example 1.

FIG. 4 illustrates a chromatogram of the saccharide mixture sample of Comparative Example 1.

FIG. 5 illustrates a chromatogram of D-(−)-mannitol in the sample containing 0.5 mg/mL of D-(−)-mannitol analyzed at 25° C. in Comparative Example 2.

FIG. 6 illustrates a chromatogram of D-(+)-glucose in the sample containing 0.5 mg/mL of D-(+)-glucose analyzed at 25° C. in Comparative Example 2.

FIG. 7 illustrates a chromatogram of D-(+)-xylose in the sample containing 0.5 mg/mL of D-(+)-xylose analyzed at 25° C. in Comparative Example 2.

FIG. 8 illustrates a chromatogram of D-(−)-mannitol in the sample containing 0.5 mg/mL of D-(−)-mannitol analyzed at 80° C. in Comparative Example 2.

FIG. 9 illustrates a chromatogram of D-(+)-glucose in the sample containing 0.5 mg/mL of D-(+)-glucose analyzed at 80° C. in Comparative Example 2.

FIG. 10 illustrates a chromatogram of D-(+)-xylose in the sample containing 0.5 mg/mL of D-(+)-xylose analyzed at 80° C. in Comparative Example 2.

FIG. 11 illustrates calibration curves of D-(+)-xylose, D-(+)-glucose, and D-(−)-mannitol, respectively, determined in Comparative Example 2.

FIG. 12 illustrates an assumed reaction mechanism of the separating agent of Example 1 and D-glucose, where the separating agent serves as base.

### DESCRIPTION OF EMBODIMENTS

Chromatographic Separating Agent

The chromatographic separating agent of the present invention comprises a porous substrate surface-modified with silane functional groups. The silane functional group is represented by the general formula:

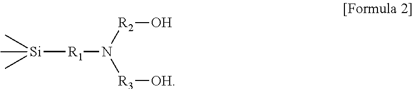

and characterized by a tertiary amine and terminal hydroxyl groups. Such a structure provides the chromatographic separating agent which exhibits excellent performances in separation of organic compounds, such as reducing sugars without formation of Schiff bases and anomer separation in analysis of saccharides.

The mechanism of the improvement in separating performances of the separating agent caused by the silane functional groups having a tertiary amino group and terminal hydroxyl groups is not clear, but is supposed as follows: the silane functional groups in the separating agent of the invention contribute to improved hydrophilicity and low cation exchange capacity due to the tertiary amino groups and hydroxyl groups, i.e. the separating agent exhibits a plurality of interactions with an analyte, which may improve separating performances. In particular, in analysis of organic compounds such as reducing sugars, the tertiary amino group probably does not react with an aldehyde group of reducing sugars, due to its high steric hindrance, resulting in the formation of no Schiff base between reducing sugars and the separating agent. Even in analysis of reducing sugars present in the form of two diastereomers, the basicity of the tertiary amino group probably increases the anomer conversion rate of the reducing sugars, resulting in no anomer separation.

The surface of the separating agent of the invention is hydrophilic because of the hydrogen bonding capacity of the tertiary amine and the hydroxyl groups. The separating agent of the invention thus can be suitably applied to HILIC (hydrophilic interaction chromatography) which uses a hydrophilic stationary phase or to normal-phase chromatography, but may also be applied to other types of chromatography.

Any porous substrate may be used in the present invention that can be surface-modified with silane functional groups and may be any known material for chromatographic separating agent (or stationary phase). The porous substrate may be in any form, for example, particulate material or bulk material such as monolith. In other words, the porous substrate may be either porous particles or a porous bulk body. The porous substrate is typically at least one selected from the group consisting of porous inorganic particles, a porous inorganic bulk body, porous polymer particles, and a porous polymer bulk body, and is preferably porous inorganic particles or porous inorganic balk materials, particularly preferably porous inorganic particles. Examples of the porous inorganic particles or porous inorganic bulk body include silica gel, alumina-silica gel, other ceramic particles having surface hydroxyl groups, and silica monoliths, particularly preferably silica gel. Silica gel is preferred because of its high mechanical strength in view of high-throughput analysis. Examples of the porous polymer particles include cellulose particles, agarose particles, and other porous polymer particles having surface hydroxyl groups. The porous substrate after surface modification with silane functional groups may either retain the original hydroxyl groups or lack them due to a silylation reaction.

If silica gel is used as a porous substrate, functional groups with strong basicity generally cause dissolution of silica gel, resulting in rapid degradation of a packing medium. In this regard, the tertiary amine contained in the separating agent of the invention have low basicity in aqueous solution, and are supposed to be less likely to cause degradation of silica gel as compared to primary or secondary amines. Furthermore, the tertiary amine having hydroxyl groups exhibits lower basicity, and is supposed to be less likely to cause dissolution of silica gel, resulting in improved durability, as compared to a tertiary amine with no hydroxyl group.

An analyte likely to undergo anomer separation is generally analyzed at a high temperature of about 80° C. for prevention of anomer separation. However, high-temperature analysis accelerates degradation of silica gel-based separating agents. In this regard, the separating agent of the invention achieves analysis without anomer separation at a lower temperature (for example, 25° C.) and is less likely to be degraded. Accordingly, the separating agent of the present invention is preferably used at a separation temperature of 50° C. or lower, more preferably 10° C. to 50° C., more preferably 15° C. to 40° C., particularly preferably 20° C. to 30° C.

The porous substrate is surface-modified with silane functional groups. Typically, silane functional groups are attached to the surface of the porous substrate via a reaction between hydroxyl groups (e.g. silanol groups in the case of silica gel) on the surface of the porous substrate and a silylating agent.

The silane functional group has a linking group R₁ composed of an alkylene or oxyalkylene group having a carbon number of 1 to 10 between silicon of the silane functional group and nitrogen of the tertiary amine. Examples of the alkylene group include methylene, dimethylene (ethylene), trimethylene, tetramethylene, pentamethylene, hexamethylene, propylene, and ethylethylene groups. Examples of the oxyalkylene group include oxymethylene, oxydimethylene (oxyethylene), oxytrimethylene, oxytetramethylene, oxypentamethylene, oxyhexamethylene, and oxypropylene groups. The alkylene or oxyalkylene group has a carbon number of 1 to 10, preferably 1 to 7, more preferably 1 to 6, even more preferably 1 to 5, particularly preferably 2 to 4, most preferably 3. A typical linking group R₁ is represented by —(CH₂)ₘ—, wherein m is 1 to 10, preferably 1 to 7, more preferably 1 to 6, even more preferably 1 to 5, particularly preferably 2 to 4, most preferably 3. In other words, a particularly preferred linking group R₁ is —(CH₂)₃—.

R₂ and R₃ groups in the silane functional group independently have an alkylene or alkyleneoxyalkylene group with a carbon number of 1 to 6. The alkylene or oxyalkylene group preferably has a carbon number of 1 to 6, more preferably 1 to 3, even more preferably 2. Typical R₂ and R₃ groups are represented by —(CH₂)ₙ—, wherein n is 1 to 6, preferably 1 to 4, more preferably 1 to 3, even more preferably 2. In other words, particularly preferred R₂ and R₃ groups are —(CH₂)₂—.

Accordingly, in the most preferred silane functional group, R₁ is —(CH₂)₃— and R₂ and R₃ are —(CH₂)₂—, as is represented by the formula:

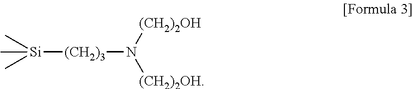

The separating agent of the invention can be prepared by silylation reaction between a silylating agent having the above-described silane functional group and a porous substrate (typically hydroxyl groups present on its surface). The silylation reaction may be performed under any known condition.

Chromatographic Column

The separating agent of the present invention is used to provide a chromatographic column. The chromatographic column of the invention comprises a cylindrical column body and the chromatographic separating agent of the invention packed or formed in the column body. The column body may be composed of any material, including stainless steel or glass, for example. The column body may have any inner diameter and length appropriately determined depending on the intended use. The separating agent may be packed or formed in the column body by any process. For example, the separating agent in the form of particles may be packed in the column body, or a porous substrate in the form of a bulk material, such as monolith (for example, monolithic silica gel), may be formed in the column body (for example, a capillary tube). In other words, the chromatographic column of the invention may be in the form of a monolithic capillary column.

Chromatographic Separating Method

The chromatographic separating agent of the invention or a chromatographic column containing the separating agent can be used for separation of a plurality of substances. In other words, the chromatographic separating method of the present invention comprises the step of separating a plurality of substances using the inventive chromatographic separating agent. More specifically, the separating agent of the invention is used as a chromatographic stationary phase. A chromatographic mobile phase may be any of liquids, gases, and supercritical fluids, preferably liquids or supercritical fluids. In other words, the separating method of the invention may be any separating method based on the principle of chromatography, and includes any type of chromatography as a chemoanalytical technique and also solid-phase extraction, which is one of methods for separation or concentration of a compound as a pretreatment for a chemical analysis. The separating method of the invention may be used in any of liquid chromatography (for example, high-performance liquid chromatography (HPLC)), gas chromatography, and supercritical chromatography, preferably liquid or supercritical fluid chromatography. The liquid chromatography may be performed in any separation mode, including normal-phase chromatography, HILIC (hydrophilic interaction chromatography), or reverse-phase chromatography. Normal-phase chromatography or HILIC (one form of normal-phase chromatography) is particularly preferred, since the separating agent of the invention may have favorable properties for a hydrophilic stationary phase. The separation temperature is preferably 50° C. or lower, more preferably 10° C. to 50° C., even more preferably 15° C. to 40° C., particularly preferably 20° C. to 30° C., for prevention of degradation of a porous substrate such as silica gel.

Any plurality of substances may be subjected to separation, but preferably at least one, more preferably at least two, of the substances are saccharides (for example, reducing sugars) because the separating agent of the invention exhibits excellent performances particularly in analysis of organic compounds such as reducing sugars.

### EXAMPLES

The present invention will now be explained in further details by way of the following examples.

### Example 1

### (1) Synthesis of Separating Agent

Porous silica gel (10 g) with a mean particle diameter of 5 μm, a mean pore size of 12 nm, and a specific surface area of 300 m²/g was dispersed in toluene (50 mL), and bis(2-hydroxyethyl)-3-aminopropyltrimethoxysilane (11 g) was added to the dispersion. The dispersion was refluxed at elevated temperature to allow the reaction to proceed for six hours. The dispersion was then cooled to room temperature, and the silica gel after the reaction was filtrated, washed, and dried under reduced pressure, to prepare a chromatographic separating agent of silica gel surface-modified with silane functional groups represented by the general formula:

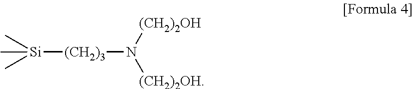

The resulting separating agent was subjected to elemental analysis, and was found to contain 4.53% C, 0.56% H, and 0.57% N.

### (2) Evaluation of Chromatographic Performances in HILIC Mode

The resulting separating agent was packed in a stainless steel column body (length: 250 mm; inner diameter: 4.6 mm) to prepare a chromatographic column. The chromatographic column was evaluated for chromatographic performances in a HILIC mode (Evaluations 1 and 2) with some or all of the following compounds:

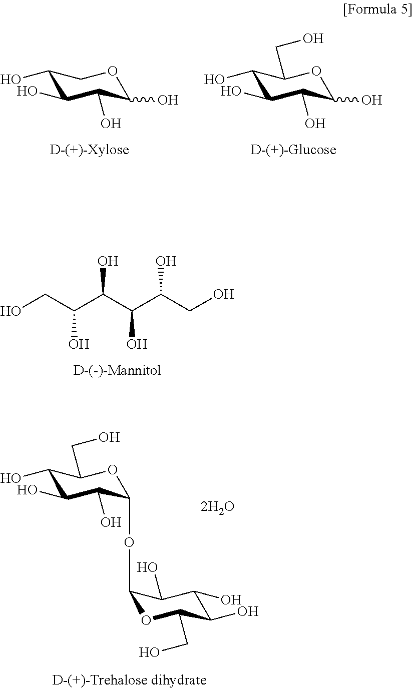

### Evaluation 1: Preparation of Calibration Curves

Standard sample solutions were prepared, each containing one of the following three saccharides. The concentration of each sample was selected from the following concentrations. The samples were analyzed with the chromatographic column under the following conditions.

Samples:

D-(+)-xylose, 0.5 mg/mL, 0.25 mg/mL, 0.125 mg/mL, or 0.0625 mg/mL,
D-(+)-glucose, 0.5 mg/mL, 0.25 mg/mL, 0.125 mg/mL, or 0.0625 mg/mL, and
D-(−)-mannitol, 0.5 mg/mL, 0.25 mg/mL, 0.125 mg/mL, or 0.0625 mg/mL
Mobile phase: acetonitrile/water=75/25
Flow rate: 1.0 mL/min.
Temperature: 25° C.
Detection: RI (differential refractometer)
Sample injection volume: 20 μL

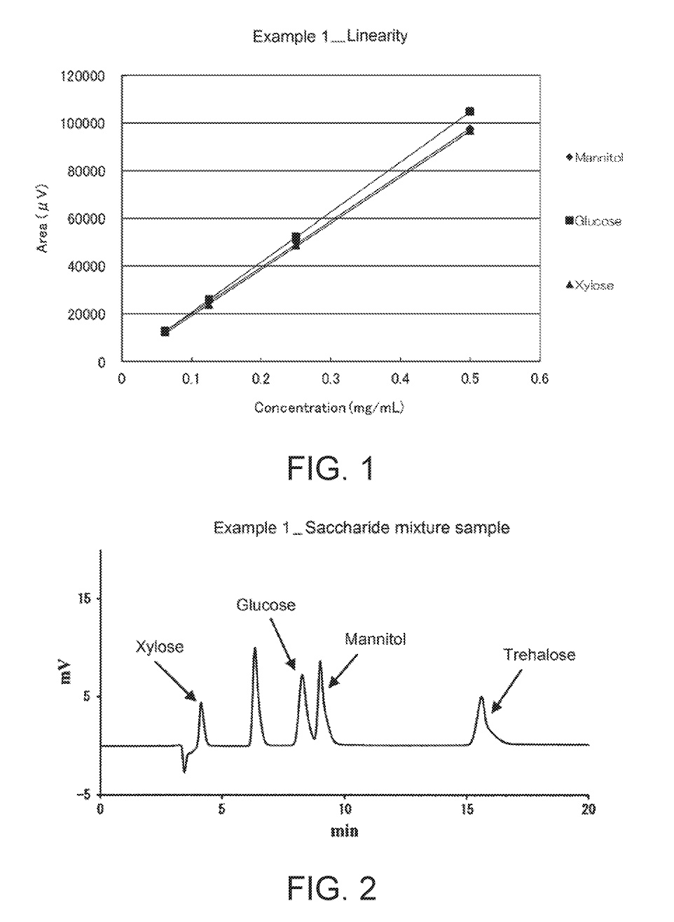

The resulting calibration curves illustrated in FIG. 1 showed excellent linearity and exhibited no reduction in yields of the reducing sugars, glucose and xylose. Such results suggest that no Schiff base formation occurred between the separating agent of Examples 1 having the tertiary amine and the reducing sugars, glucose and xylose, and that neither of the reducing sugars, glucose and xylose, underwent anomer separation even at 25° C., implying that the separating agent of Example 1 acted as a base on the reducing sugars to promote anomer conversion, as shown in FIG. 12.

### Evaluation 2: Separation of Saccharide Mixture

A sample solution was prepared to contain the following four saccharides at the indicated concentrations, and was analyzed with a chromatographic column under the following analytical conditions:

Sample:

D-(+)-xylose, 0.8 mg/mL,
D-(+)-glucose, 0.8 mg/mL,
D-(−)-mannitol, 0.8 mg/mL, and
D-(+)-trehalose dihydrate, 0.8 mg/mL
Mobile phase: acetonitrile/water=85/15
Flow rate: 1.0 mL/min.
Temperature: 25° C.
Detection: RI (differential refractometer)
Sample injection volume: 20 μL

The results are illustrated in the chromatogram of FIG. 2. As seen from FIG. 2, the four saccharides (xylose, glucose, mannitol, and trehalose) in the saccharide mixture sample were sufficiently separated. The results indicate that the separating agent and the column prepared in Example 1 have high performances in separation of saccharides.

### Comparative Example 1

Comparative Example 1 shows one of the most common separating agents used in analysis of saccharides in a HILIC mode.

(1) Synthesis of Separating Agent

Porous silica gel (10 g) with a mean particle diameter of 5 μm, a mean pore size of 12 nm, and a specific surface area of 300 m²/g was dispersed in toluene (50 mL), and 3-aminopropyltriethoxysilane (4 g) was added to the dispersion. The dispersion was refluxed at elevated temperature to allow the reaction to proceed for six hours. The dispersion was then cooled to room temperature, and the silica gel after the reaction was filtrated, washed, and dried under reduced pressure, to prepare a chromatographic separating agent of silica gel surface-modified with silane functional groups represented by the general formula:

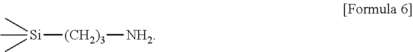

The resulting separating agent was subjected to elemental analysis, and was found to contain 5.38% C, 1.01% H, and 1.54% N.

(2) Evaluation of Chromatographic Performances in HILIC Mode

The resulting separating agent was subjected to Evaluations 1 and 2 for chromatographic performances in a HILIC mode as in Example 1.

### Evaluation 1: Preparation of Calibration Curves

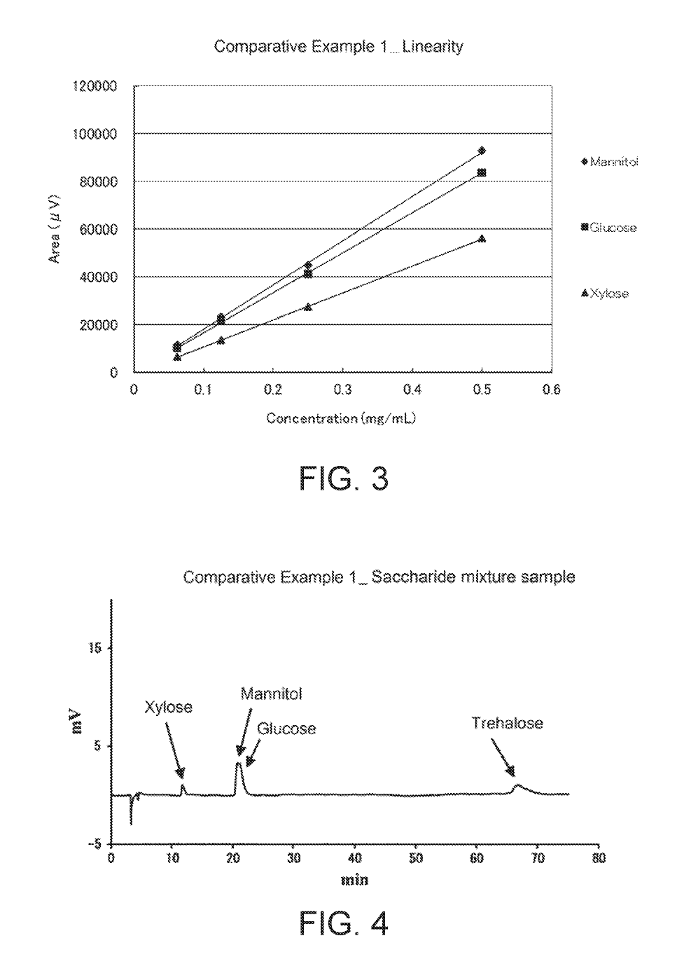

Evaluation 1 was performed as in Example 1, to give the calibration curves for respective saccharides, illustrated in FIG. 3. As seen from FIG. 3, the yield of glucose, a reducing sugar, was low, and that of xylose, another reducing sugar, was still lower. This suggests that Schiff base formation occurred between the reducing sugars, glucose and xylose, and the separating agent of Comparative Example 1. The separating agent of Comparative Example 1 was basic, and thus caused no anomer separation of the reducing sugars.

### Evaluation 2: Separation of Saccharide Mixture

Evaluation 2 was performed as in Example 1 to give the chromatogram illustrated in FIG. 4. As seen from FIG. 4, the separating agent failed to separate glucose and mannitol from each other.

### Comparative Example 2

Comparative Example 2 shows a separating agent having a quaternary ammonium group, which has high steric hindrance and causes no Schiff base formation with organic compounds such as reducing sugars.

(1) Synthesis of Separating Agent

Porous silica gel (10 g) with a mean particle diameter of 5 μm, a mean pore size of 12 nm, and a specific surface area of 300 m²/g was dispersed in toluene (50 mL), and N-(trimethoxysilylethyl)benzyl-N,N,N-trimethylammonium chloride (10 g) was added to the dispersion. The dispersion was refluxed at elevated temperature for six hours to complete the reaction. The dispersion was then cooled to room temperature, and the silica gel after the reaction was filtrated, washed, and dried under reduced pressure, to prepare a chromatographic separating agent of silica gel surface-modified with silane functional groups represented by the general formula:

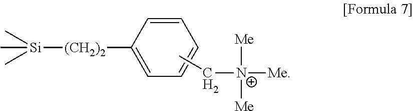

The resulting separating agent was subjected to elemental analysis, and was found to contain 10.66% C, 1.63% H, and 0.96% N.

(2) Evaluation of Chromatographic Performances in HILIC Mode

The resulting separating agent was subjected to Evaluation 1 for chromatographic performances in a HILIC mode as in Example 1.

### Evaluation 1: Preparation of Calibration Curves

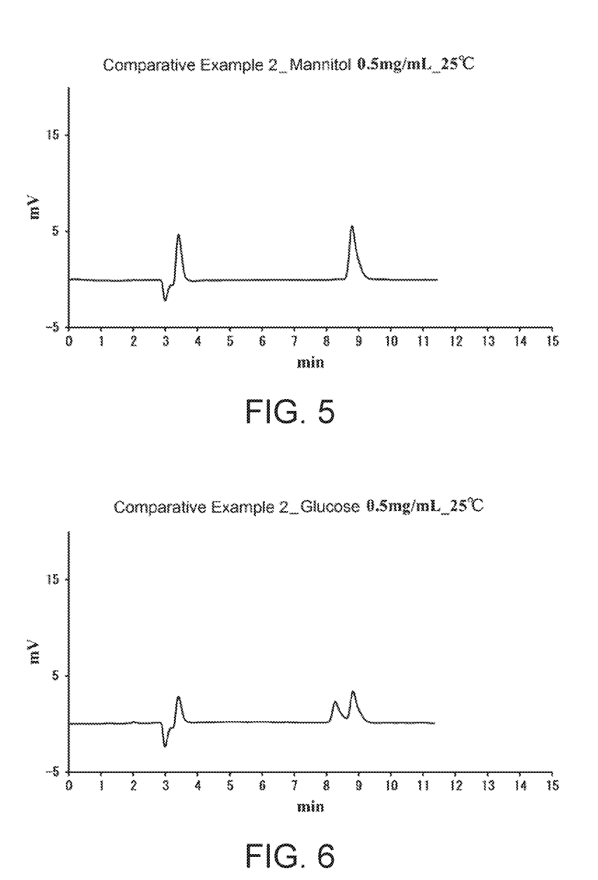

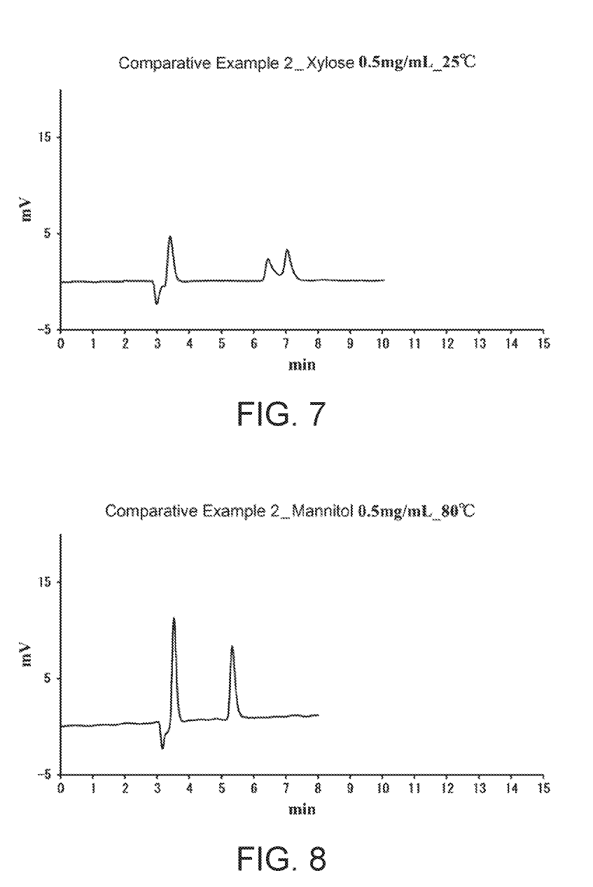

Analyses were performed as in Evaluation 1 of Example 1, to give the chromatograms illustrated in FIGS. 5 to 7. FIG. 5 shows that mannitol was detected without split peaks, whereas FIGS. 6 and 7 show that glucose and xylose, reducing sugars, were each detected with split peaks, suggesting that the reducing sugars, glucose and xylose, underwent anomer separation. The reason was supposed as follows: the separating agent of Comparative Example 2 has a quaternary ammonium group and serves as a highly basic stationary phase, but cannot accept protons unlike Lewis bases; hence it did not serve as a base to promote anomer conversion, resulting in anomer separation.

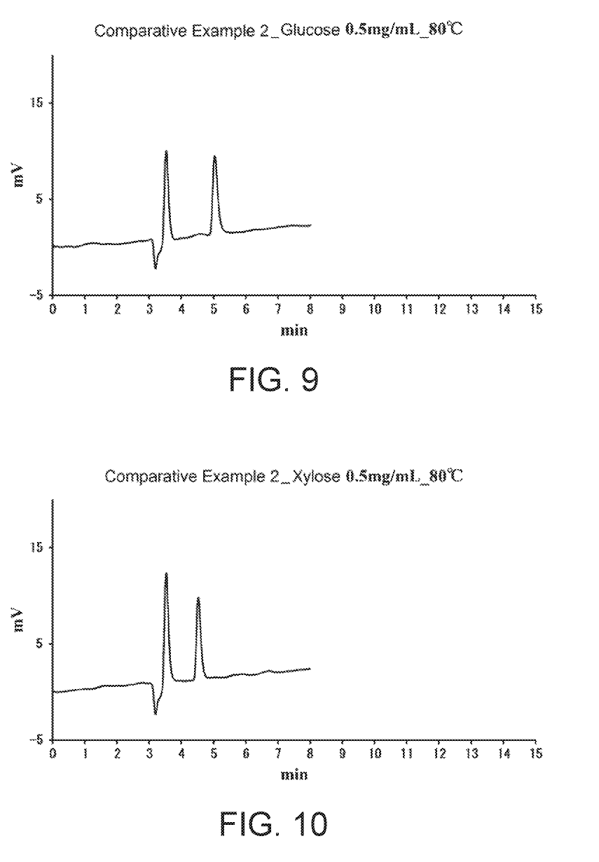

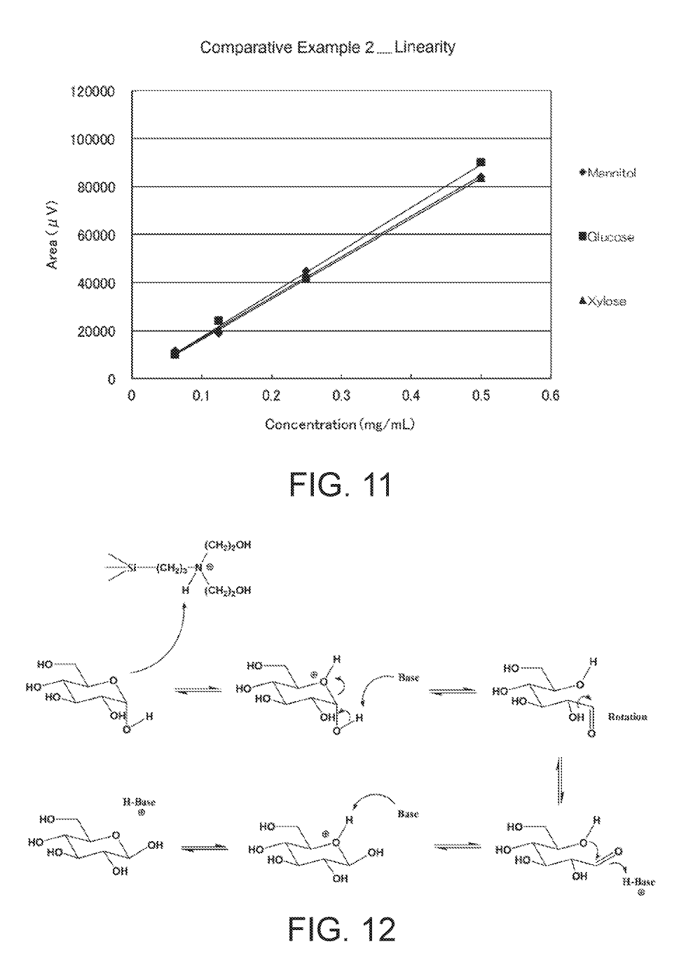

The separating agent was then analyzed as in Evaluation 1 of Example 1, except that the temperature was varied from 25° C. to 80° C. As a result, each sample was separated as shown in FIGS. 8 to 10. Glucose and xylose were each detected without split peaks, as shown in FIGS. 9 to 10, suggesting that no anomer separation occurred. The calibration curves illustrated in FIG. 11 show linearity, and exhibits no significant reduction in yields of reducing sugars, glucose and xylose. Such results indicate that no Schiff base formation occurred between the reducing sugars and the separating agent of Comparative Example 2.

The separating agent of Comparative Example 2, however, required a long time until the equilibration of the mobile phase fed in the column, because it served as a highly basic stationary phase. Furthermore, FIGS. 8 to 10 show noticeable baseline drifts as compared to those with other stationary phases, and the calibration curves show lower linearity than that of Example 1. Accordingly, the separating agent of Comparative Example 2 is inadequate for analysis of trace amounts of components.

### CONCLUSION

Table 1 shows the analytical results of the reducing sugars using the separating agents of Example 1 and Comparative Examples 1 and 2. For evaluation of analytical reproducibility of each separating agent, CV (coefficient of variation) was calculated based on the peak area for 0.0625 mg/mL xylose, which had a relatively large variation in the peak area among the three measurements repeated for each concentration. The calculated CV values are also shown in the table.

TABLE 1

| | | | CV (coefficient |
|---|---|---|---|
| | Anomer separation of | | of variation) |
| | reducing sugars at | Schiff base | for 0.0625 mg/mL |
| | 25° C. | formation | xylose (%) |
| Example 1 | not observed | not observed | 0.83 |
| Comparative | not observed | observed | 8.08 |
| Example 1 | | | |
| Comparative | observed | not observed | 11.22 |
| Example 2 | | | |

Table 1 shows that Example 1 caused no Schiff base formation between the reducing sugars and the separating agent and caused no anomer separation of the reducing sugars at 25° C., indicating that the separating agent of Example 1 exhibits excellent performances in analysis of saccharides. The results also demonstrate that Example 1 advantageously shows a relatively high analytical reproducibility.

The results of the analytical reproducibility for the individual separating agents will now be discussed. The separating agent of Example 1 exhibited high yields in samples containing trace concentrations of saccharides, and is also supposed to show a small variation in the peak area, due to the stable baseline of the chromatogram. The separating agent of Comparative Example 1 exhibited low elution of xylose from the column, because of the Schiff base formation between xylose and the separating agent, indicating low yields and a large variation in the peak area in samples containing trace concentrations of saccharides. The separating agent of Comparative Example 2 exhibited baseline drifts in the chromatograms, indicating large variations in the peak areas in samples containing trace concentrations of saccharides.

1. A chromatographic separating agent comprising a porous substrate surface-modified with silane functional groups represented by the formula: 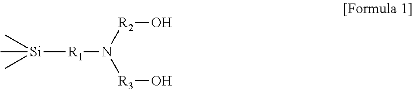
wherein R₁ represents an alkylene group or oxyalkylene group having a carbon number of 1 to 10; and R₂ and R₃ independently represent an alkylene group or alkyleneoxyalkylene group having a carbon number of 1 to 6.

2. The chromatographic separating agent according to claim 1, wherein R₁ is —(CH₂)ₘ— wherein m is 1 to 10.

3. The chromatographic separating agent according to claim 1, wherein R₂ and R₃ are independently —(CH₂)ₙ— wherein n is 1 to 6.

4. The chromatographic separating agent according to claim 1, wherein R₁ is —(CH₂)₃— and R₂ and R₃ are —(CH₂)₂—.

5. The chromatographic separating agent according to claim 1, wherein the porous substrate is at least any one selected from the group consisting of porous inorganic particles, a porous inorganic bulk body, porous polymer particles, and a porous polymer bulk body.

6. The chromatographic separating agent according to claim 1, wherein the porous substrate is porous inorganic particles or a porous inorganic bulk body, the porous inorganic particles or porous inorganic bulk body being silica gel.

7. A chromatographic column comprising:
a cylindrical column body; and
the chromatographic separating agent of claim 1 packed or formed in the column body.

8. A chromatographic separating method comprising the step of separating a plurality of substances using the chromatographic separating agent of claim 1.

9. The separating method according to claim 8, wherein at least one of the plurality of substances is saccharide.
